(19) United States
(12) Patent Application Publication
(10) Pub. No.: US 2007/0034035 A1
(43) Pub. Date: Feb. 15, 2007

(54) Pinion motor

(75) Inventor: Yasushi Mineshima, Kurashiki-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, Ltd.

(21) Appl. No.: 11/491,950

(22) Filed: Jul. 25, 2006

(30) Foreign Application Priority Data
Jul. 26, 2005 (JP) 2005-216305

(51) Int. Cl. F16H 1/14

(52) U.S. Cl. 74/423

(57) ABSTRACT

In a pinion motor having a pinion formed on the motor shaft that is supported by a load side bearing and a counter-load side bearing, the motor includes an accompanying instrument that requires precise control of the axial distance with respect to the motor shaft within a predetermined range of the axial distance. The counter-load side bearing has an inner ring securely coupled to the motor shaft and an outer ring securely coupled to the motor case. The load side bearing has an inner ring coupled to the motor shaft with a close fit and an outer ring coupled to the motor case with a clearance fit.

### BACKGROUND OF THE INVENTION

1. Field of the Invention

The present invention relates to a pinion motor having a pinion formed on the motor shaft.

2. Description of the Related Art

In factories or the like in recent years, there are more demands for equipment configurations that allow independent drive of separate machines so that only necessary machines are operated only when required, in order to be capable of large variety and small amount production. Accordingly, there are more needs for so-called “geared motors,” which include a gear box accommodating a reduction mechanism and integrally assembled with a motor so that they can alone provide power output with appropriately adjusted torque and rotation speed.

In response to this trend, a wide range of pinion motors have come to the market, which include a spur pinion (spur gear) or a helical pinion (helical gear) or the like integrally formed to the motor shaft, which thereby doubles as the first stage (input shaft) of a reducer.

The motor shaft of such pinion motors is assembled such that it can slightly move in the axial direction relative to the motor case, taking into account thermal expansion caused by the heat of the motor. The pinion motor disclosed in Japanese Patent Laid-Open Publication No. 2001-124155 adopts a structure in which the bearing (load side bearing) supporting the pinion side (load side) of the motor shaft has a press fit and the other (counter-load side bearing) has a clearance fit, with a washer W being provided for applying preload to the clearance fit counter-load side bearing.

Some motors include an RPM sensor or a braking device, or various other accompanying instruments depending on their applications. Many of these accompanying instruments are designed such that the axial distance between the motor shaft (or a component of the accompanying instrument partly secured to the motor shaft) and another specified component of the accompanying instrument is controlled within a predetermined range of axial distance, e.g., a rotary plate and a sensor mechanism of the RPM sensor, or a movable plate and a stationary magnet of the braking device.

However, when such accompanying instruments are incorporated in pinion motors, the problem was that the above-mentioned motor shaft motion makes imprecise this axial distance that should be strictly controlled, badly affecting the performance of the RPM sensor or braking device.

### SUMMARY OF THE INVENTION

In view of the foregoing problems, various exemplary embodiments of this invention provide a pinion motor with a configuration that allows provision of a precise clearance (axial distance) necessary for the performance of an accompanying instrument of the motor and that can effectively accommodate thermal expansion of the motor shaft.

To solve the above problems, the present invention provides a pinion motor with a pinion formed on a motor shaft that is supported by a load side bearing and a counter-load side bearing, the pinion motor including an accompanying instrument configured such that an axial distance between the motor shaft or a component of the accompanying instrument partly secured to the motor shaft and another component of the accompanying instrument is controlled to be within a predetermined range of axial distance, wherein an inner ring of the counter-load side bearing is secured to the motor shaft and an outer ring of that is secured to a motor case, and an inner ring of the load side bearing is tightly fitted (close fit) with the motor shaft and an outer ring of that is loosely fitted (clearance fit) with the motor case.

The “motor case” used herein means the main body of the motor case and also includes the concept of other components fixed on the main body of the motor case (motor case side components).

According to the present invention, the counter-load side bearing, which is the bearing on the side on which an accompanying instrument such as an RPM sensor or a braking device is provided, has both its inner ring and outer ring firmly secured to the motor shaft and to the case. This ensures that a clearance (axial distance) that is necessary for the performance of the accompanying instrument is reliably secured. On the other hand, the load side bearing has its outer ring making a clearance fit, and only the inner ring makes a close fit. Accordingly, thermal expansion of the motor shaft is effectively accommodated. Furthermore, the structure allows easier assembly than the structure in which the inner ring makes a clearance fit.

Also, any axial loads that may be created on the pinion can be reliably supported by the counter-load side bearing.

The configuration allows provision of a precise clearance or the like necessary for the performance of the accompanying instrument of the motor and can effectively accommodate thermal expansion of the motor shaft.

### BRIEF DESCRIPTION OF THE DRAWINGS

FIG. 1 is a cross-sectional view illustrating one exemplary embodiment of a pinion motor and a geared motor with the pinion motor to which the present invention is applied;

FIG. 2 is an enlarged cross-sectional view of the vicinity of the RPM sensor in the above exemplary embodiment;

FIG. 3 is a cross-sectional view illustrating another exemplary embodiment of the present invention similarly to FIG. 1; and

FIG. 4 is an enlarged cross-sectional view of the vicinity of the braking device in the above exemplary embodiment.

### DETAILED DESCRIPTION OF THE PREFERRED EMBODIMENTS

Preferred exemplary embodiments of the present invention will be hereinafter described in detail with reference to the drawings.

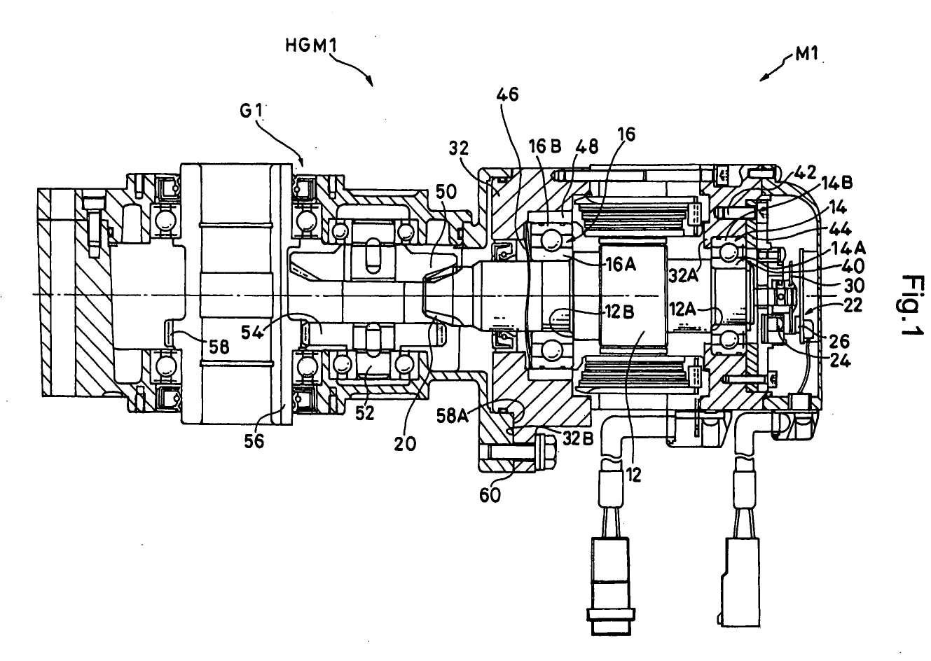

FIG. 1 illustrates a motor with a hypoid pinion to which the present invention is applied, as well as a hypoid reducer integrated with this motor, i.e., the drawing shows a hypoid geared motor (power transmission device) incorporating the features of the present invention.

The motor M1 includes the motor shaft 12. The motor shaft 12 is rotatably supported on both sides by a load side bearing 16 and a counter-load side bearing 14 (to be described later). A hypoid pinion 20 is formed at the tip of the motor shaft 12, while an RPM sensor 22 is mounted at the rear end.

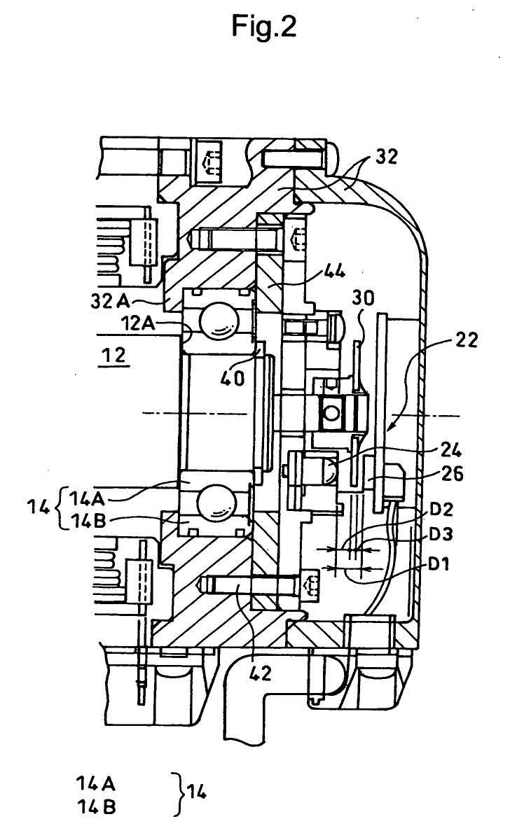

In this exemplary embodiment, as shown in FIG. 2, the RPM sensor 22 includes a light emitter 24 that emits light and a light receptor 26 that receives emitted light. A rotary plate 30 formed with a slit (not shown) is rotatably arranged between the light emitter 24 and the light receptor 26. The light emitter 24 and the light receptor 26 are secured (fixed) to the case 32 of the motor M1 with a clearance D1 therebetween. The rotary plate 30 rotates integrally with the motor shaft 12 within this clearance D1. Therefore, as the slit formed in the rotary plate 30 rotates synchronously with the motor shaft 12, the light emitted from the light emitter 24 reaches the light receptor 26 intermittently with a speed in accordance with the rotation speed of the motor shaft 12, based on which the rotation state of the motor shaft 12 is detected.

While the clearance D1 between the light emitter 24 and the light receptor 26 is illustrated somewhat wider in FIG. 1 and FIG. 2 for ease of illustration, the clearance D1 is actually not designed as wide as this for good efficiency of light emission and reception and for clear detection of transmission and interception of light. The rotary plate 30, which rotates at high speed, is located substantially at the center in the axial direction within this small clearance D1. Accordingly, the clearance D2 between the light emitter 24 and the rotary plate 30, and the clearance D3 between the light receptor 26 and the rotary plate 30, must be strictly controlled and secured. In this exemplary embodiment, the clearances D2 and D3 correspond to the axial distances between a component (rotary plate 30) integral with the motor shaft 12 and other specified components (light emitter 24 and light receptor 26), respectively.

The bearing 14, which supports the counter-load side of the motor shaft 12, has an inner ring 14A securely coupled to the motor shaft 12 by a close fit. Furthermore, the inner ring 14A is held between a snap ring 40 mounted on the motor shaft and a step 12A formed to the motor shaft 12, so that it is completely prevented from moving in the axial direction relative to the motor shaft 12.

Also, an outer ring 14B of the (counter-load side) bearing 14 is held between a projection 32A formed to the case 32 of the motor M1 and a flange 44 secured to the case 32 with bolts 42, so that the outer ring 14B is secured to the case 32 and completely prevented from moving in the axial direction relative to the case 32.

Referring back to FIG. 1, the bearing 16 that supports the load side of the motor shaft 12 has an inner ring 16A securely coupled to the motor shaft 12 by a close fit. One end of the inner ring 16A abuts with a step 12B formed to the motor shaft 12, while the other end abuts with a plate spring (elastic member) 46. Note, this plate spring 46 biases the inner ring 16A toward the right side of the drawing, which is to say, the plate spring 46 biases the motor shaft 12 towards the counter-load side bearing 14 via the inner ring 16A.

An outer ring 16B of this (load side) bearing 16 is contacted and coupled to a bush 48 assembled in the case 32 with a clearance fit (axially slidably).

At the tip of the motor shaft 12 is formed the hypoid pinion 20 as mentioned before. This hypoid pinion 20 meshes with a hypoid gear 50 set in the reducer (driven machine) G1, constituting a hypoid reduction mechanism. An intermediate shaft 52, to which the hypoid gear 50 is attached, has a gear 54. The gear 54 meshes with a pinion 58 integrally formed with the output shaft 56. The gear 54 and the pinion 58 form a speed increaser mechanism and contribute to the low reduction ratio of the entire hypoid geared motor HGM1.

At one end of the case 32 of the motor M1 is formed an attachment surface 32B for the reducer, and correspondingly, at one end of the case 58 of the reducer G1 is formed an attachment surface 58A for the motor case. A shim 60 can be inserted between these attachment surfaces 32B and 58A. The shim 60 enables slight adjustment of the meshing position between the hypoid pinion 20 on the motor M1 side and the hypoid gear 50 on the reducer G1 side.

Next, the effects of this exemplary embodiment of the hypoid pinion motor M1 and the hypoid geared motor HGM1 will be described.

When the motor shaft 12 rotates, the hypoid pinion 20 at the tip rotates with the motor shaft 12, rotating the hypoid gear 50 meshing with the hypoid pinion 20. The hypoid gear 50 rotates the intermediate shaft 52, and in turn the gear 54 assembled to the intermediate shaft 52. As a result, the output shaft 56 rotates through the pinion 58 that meshes with this gear 54.

Here, in order to allow stable high-speed rotation of the rotary plate 30 of the RPM sensor 22 without touching either of the light emitter 24 and the light receptor 26, the clearances D2 and D3 must strictly be controlled. In this exemplary embodiment, the precise positioning is achieved using the bearing 14 on the counter-load side of the motor shaft 12.

That is, the inner ring 14A of the bearing 14 that supports the counter-load side of the motor shaft 12 is mounted to the motor shaft 12 with a close fit, and, the inner ring 14A is held between the step 12A on the motor shaft 12 and the snap ring 40, so that the inner ring 14A is completely immobile in the axial direction relative to the motor shaft 12. On the other hand, the outer ring 14B of this counter-load side bearing 14 is held between the projection 32A formed on the case 32 side and the flange 44 secured to the case 32 with the bolts 42, so that the outer ring 14B is secured to the case 32 and completely immobile in the axial direction relative to the case 32. Therefore, the counter-load side end of the motor shaft 12 and the rotary plate 30 that is integral with the motor shaft are precisely positioned in the axial direction relative to the case 32 through the counter-load side bearing 14. Since the light emitter 24 and the light receptor 26 of the RPM sensor 22 are components that are attached to the case 32 side, their axial positioning precision relative to the case 32 is originally high. As a result, the rotary plate 30 integral with the motor shaft 12 can be arranged between other specified components, in this case the light emitter 24 and the light receptor 26, (with clearances D2 and D3) with a very high precision.

Thrust loads (loads in the axial direction) created by the engagement between the hypoid pinion 20 and the hypoid gear 50 are reliably supported by the case 32 through this counter-load side bearing 14.

In other words, while there is no limitation on the type of the pinion formed at the tip of the motor shaft in the present invention, the counter-load side bearing ensures support of axial loads that will be created by the use of some types of pinions, such as, for example, hypoid pinions as with this exemplary embodiment or other orthogonally meshed pinions such as worm pinions and bevel pinions, or helical pinions.

On the other hand, the load side bearing 16 of the motor shaft 12 has the inner ring 16A assembled to the motor shaft 12 with the close fit and the outer ring 16B assembled to (the bush 48 of) the case 32 with the clearance fit (axially slidably). Accordingly, expansion and contraction of the motor shaft 12 that occur as the motor shaft 12 is heated or cooled can readily be accommodated. Also there is no rattling in the axial direction because the motor shaft 12 is always pressed towards the counter-load side bearing 14 (through the load side bearing 16) by the biasing force of the plate spring 46.

Moreover, the shim 60 can be inserted between the reducer attachment surface 32B of the case 32 of the motor M1 and the motor case attachment surface 58A of the case 58 of the reducer G1. Thus, the existence of this shim 60 enables precise, slight adjustment of the meshing position between the hypoid pinion 20 formed to the motor shaft 12 and the hypoid gear 50 on the side of the reducer G1.

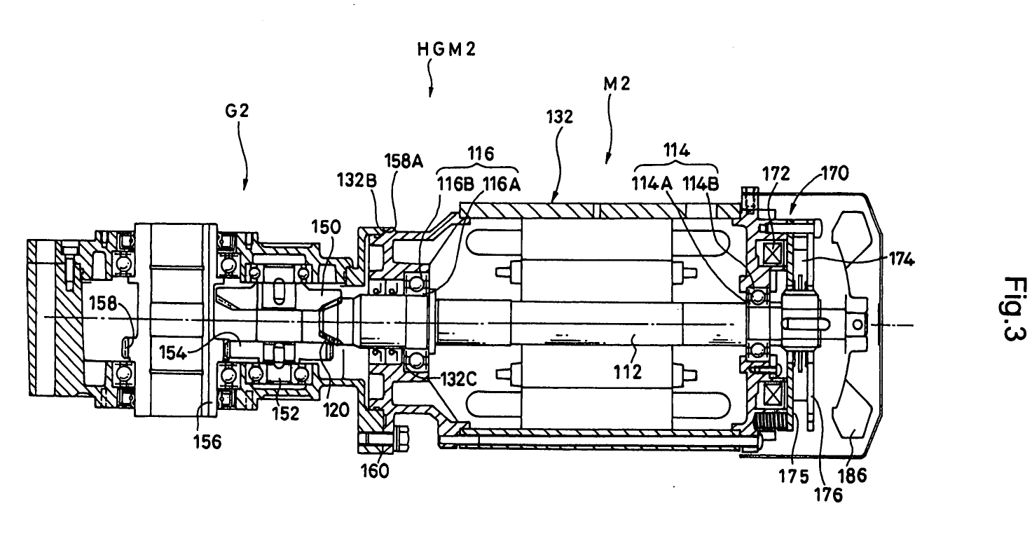

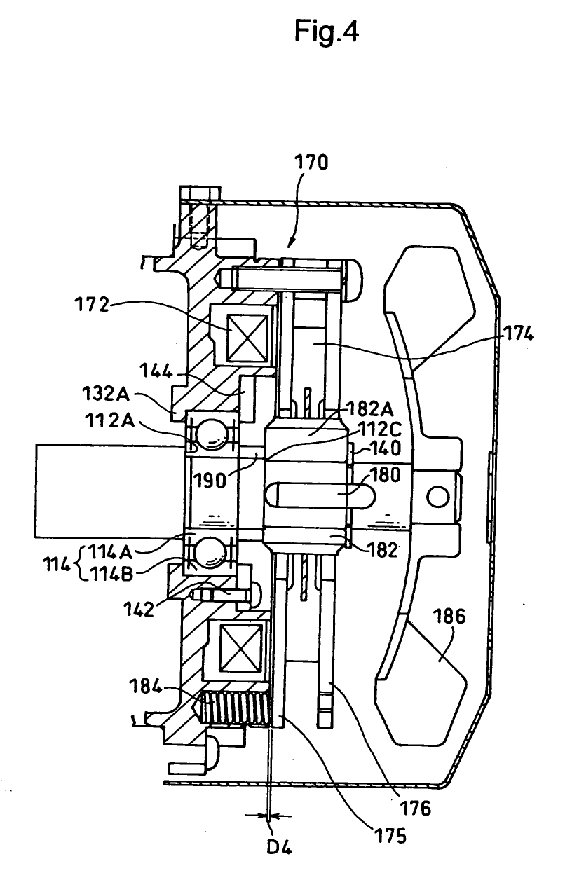

Next, another exemplary embodiment of the present invention will be described with reference to FIG. 3 and FIG. 4.

In this exemplary embodiment of the hypoid geared motor HGM2, a braking device 170 is incorporated on the counter-load side of the motor shaft 112 of the motor M2.

This braking device 170 includes a stationary magnet 172, a sliding plate (brake lining) 174, a movable plate 175, and a stationary plate 176. On the counter-load side of the motor shaft 112 is assembled a sleeve 182, which is axially secured (fixed) by a step 112C and a snap ring 140, and circumferentially united with the motor shaft through a key 180. The sliding plate 174 is assembled to the outer surface of the sleeve 182 such as to be movable in the axial direction of the sleeve 182. The sliding plate 174 engages with a projection (shown only in a cross section) 182A formed along the axial direction of the sleeve 182 so as to be able to rotate with the sleeve 182 and to move in the axial direction of the sleeve 182.

When the brake is operated, the movable plate 175 is applied power by a spring 184 in a direction in which the movable plate 175 separates from the stationary magnet 172 to press the sliding plate 174 against the stationary plate 176, so as to reduce the rotation speed of the motor shaft 112. During the motor operation the stationary magnet 172 generates a larger magnetic attraction force than the force of the spring 184 by magnetic excitation and attracts the movable plate 175, freeing the sliding plate 174 from the stationary plate 176, to release the brake. A fan 186 is attached to the farthest end of the motor shaft 112.

In the braking device 170 of this exemplary embodiment, the sum of the clearances (axial distance) between the stationary plate 176 and the sliding plate 174, between the sliding plate 174 and the movable plate 175, and between the movable plate 175 and the stationary magnet 172 must be set as small as possible while the components do not interfere with each other, when the braking device 170 is in a released position, irrespective of variations that may occur during production or assembly. This sum of the clearances, actually, can be controlled as a clearance D4 between the movable plate 175 and the stationary magnet 172 because the movable plate 175 is applied power toward the counter-load side by the spring 184 after the assembly.

Therefore, in this exemplary embodiment, the bearing 114 that supports the counter-load side of the motor shaft 112 has a structure in which the inner ring 114A is completely prevented from moving in the axial direction relative to the motor shaft 112. That is, the inner ring 114A is mounted on the motor shaft 112 with the close fit, and is held by a step 112A on the motor shaft 112 on one side and by a spacer 190, the sleeve 182, and the snap ring 140 on the other side.

The outer ring 114B of the counter-load side bearing 114 is also secured to the case 132 in a manner in which it is completely prevented from moving in the axial direction relative to the case 132. That is, the outer ring 114B is held between a projection 132A formed on the case 132 side and a flange 144 secured to the case 132 with bolts 142. This way, the counter-load side of the motor shaft 112 is precisely positioned in the axial direction relative to the case 132, so that the axial distance between the stationary plate 176 integral with the motor shaft 112 and the stationary magnet (other specified component) 172 attached on the case 132 side is precisely determined, and as a result the above-mentioned clearance D4 is precisely secured.

Referring now to FIG. 3, the bearing 116 on the load side of the motor shaft 112 has an inner ring 116A assembled to the motor shaft 112 with a close fit and an outer ring 116B assembled to the case 132 with a clearance fit (axially slidably). FIG. 3 shows a condition in which the motor shaft 112 has been heated and expanded. When the shaft contracts, there will be a clearance between the outer ring and the step 132C on the case 132. Since the inner ring 116A of the bearing 116 makes the close fit with the motor shaft 112, the bearing 116 as a whole always moves in one piece with the motor shaft 112, without any axial rattling.

Moreover, as with the previous exemplary embodiment, a shim 160 can be inserted between a reducer attachment surface 132B of the case 132 of the motor M2 and a motor case attachment surface 158A of the case 158 of the reducer G2. Thus, the existence of this shim 160 enables precise, slight adjustment of the meshing position between the hypoid pinion 120 formed to the motor shaft 112 and the hypoid gear 150 on the reducer G2 side. The shim 160 (or the previously mentioned shim 60) may be omitted depending on the applications.

Other structural features and effects are the same as those of the previous exemplary embodiment and will not be described again, same or like elements in the drawings being represented by numerals with identical last two digits.

While a reducer was shown as one example of a driven machine combined with the pinion motor in the above-described exemplary embodiments, the drive machine coupled to the motor of the present invention should not be limited to the reducer. For example, orthogonal transmission devices for merely changing the direction of drive, or joints or the like that may be used as adaptors may be applied.

The invention is applicable to a pinion motor with a pinion formed at the tip of the motor shaft, particularly to a pinion motor with an accompanying instrument that requires control of an axial distance between the motor shaft and a specified component within a predetermined range, and to a power transmission device including this pinion motor.

The disclosure of Japanese Patent Application No. 2005-216305 filed Jul. 26, 2005 including specification, drawing and claim are incorporated herein by reference in its entirety.

What is claimed is:

1. A pinion motor comprising:
a pinion formed on a motor shaft of the pinion motor;
an accompanying instrument configured such that an axial distance between the motor shaft or a component of the accompanying instrument partly secured to the motor shaft and another component of the accompanying instrument is controlled to be within a predetermined range of axial distance;
a counter-load side bearing which supports one side of the motor shaft, the counter-load side bearing having an inner ring secured to the motor shaft and an outer ring secured to a motor case; and
a load side bearing which supports another side of the motor shaft, the load side bearing having an inner ring making a close fit with the motor shaft and an outer ring making a clearance fit with the motor case.

2. The pinion motor according to claim 1, wherein the motor shaft is applied power towards the counter-load side bearing through an elastic member.

3. The pinion motor according to claim 1 or 2, wherein the inner ring of the counter-load side bearing and the motor shaft are secured with a snap ring.

4. A power transmission device comprising:
a pinion motor, the pinion motor having a pinion formed on a motor shaft of the pinion motor, the pinion being either a helical pinion or an orthogonally meshed pinion;
a driven machine coupled to the pinion motor;
an accompanying instrument configured such that an axial distance between the motor shaft or a component of the accompanying instrument partly secured to the motor shaft and another component of the accompanying instrument is controlled to be within a predetermined range of axial distance;
a counter-load side bearing which supports one side of the motor shaft, the counter-load side bearing having an inner ring secured to the motor shaft and an outer ring secured to a motor case;
a load side bearing which supports another side of the motor shaft, the load side bearing having an inner ring making a close fit with the motor shaft and an outer ring making a clearance fit with the motor case; and
a shim being able to be inserted between the motor case and a case of the driven machine.
